(19) United States
(12) Patent Application Publication
(10) Pub. No.: US 2006/0081273 A1
(43) Pub. Date: Apr. 20, 2006

(54) Dense fluid compositions and processes using same for article treatment and residue removal

(76) Inventors: Wayne Thomas McDermott, Fogelsville, PA (US); Hoshang Subawalla, Macungie, PA (US); Madhukar Bhaskara Rao, Fogelsville, PA (US); Dean Van-John Roth, Center Valley, PA (US); Keith Randolph Fabregas, Nazareth, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 10/969,595

(22) Filed: Oct. 20, 2004

(51) Int. Cl. B08B 3/00

(52) U.S. Cl. 134/26; 134/34

(57) ABSTRACT

A method for removing contaminants from an article is described herein. In one embodiment, there is provided a method comprising loosening at least a portion of the contaminants by treating the article with a treatment method involving a processing fluid and/or dense processing fluid to provide a partially treated article comprising loosened contaminants; contacting the partially treated article with a dense rinse fluid comprising a dense fluid, optionally a co-solvent, and optionally an entrainer to remove liquid-based contaminants; and removing at least a portion of the loosened contaminants by exposing the partially treated article with at least one exposure method to provide a treated article wherein the selection of the at least one exposure method depends upon whether the loosened contaminants are wet or dry.

### BACKGROUND OF THE INVENTION

The presence of contaminants is detrimental to the microchip fabrication process in the manufacturing of articles such as semiconductor electronic components. Contaminants may be introduced into the article from many sources such as residues from manufacturing process steps such as lithography, etching, stripping, and chemical mechanical planarization (CMP); particulates either indigenous to and/or resulting from manufacturing processes; inorganic particulates or materials such as native or chemical oxides, and metal-containing compounds; or other sources and the contaminants can be further identified as chemically reactive, chemically non-reactive, permeable, and/or impermeable materials. Contaminants, in the form of particulates, films, or molecules, can cause a variety of defects, such as short circuits, open circuits, and silicon crystal stacking faults. These defects can cause the failure of the finished article, such as microelectronic circuits, and these failures can cause significant yield reductions, which greatly increases manufacturing costs.

Examples of particularly difficult to remove contaminants, which are defined herein as “chemically resistant contaminants” may include photoresist, anti-reflective coatings, various post-ash and post-etch residues, process-generated particles, solder flux residue and many others. More specific examples of chemically resistant contaminants include cross-linked or “process-hardened” photoresists following various processing steps such as plasma etching, chemical etching or ion implantation. Other examples of chemically resistant contaminants include multi-level photoresists containing chemically resistant glass or acrylic polymer layers over a more chemically reactive polymer sub-layer. Still other examples of chemically resistant contaminants include silica, alumina, ceria, manganese dioxide, zirconia, copper, tungsten, aluminum, silicon or dielectric particles resulting from the processes of chemical mechanical planarization (CMP), etching, and probe testing or dicing. Surface particles may also result from various film deposition or oxidation processes, or, alternatively, from breakage of articles during handling. Contaminants may be strongly adhering to the surface as a result of high surface and interfacial energies, covalent bonding or, in the case of certain particulates, partial embedment in the surface.

Microelectronic circuit fabrication requires many processing steps. Processing is performed under extremely clean conditions and the amount of contamination needed to cause fatal defects in microcircuits is extremely small. For example, an individual particle as small as 0.01 micrometer in size can result in a killer defect in a modern microcircuit. Microcontamination may occur at any time during the many steps needed to complete the microcircuit. Therefore, periodic cleaning of the articles used for microelectronic circuits, such as wafers, is needed to maintain economical yields. Also, tight control of purity and cleanliness of the processing materials is required.

Cleaning is the most frequently repeated step in the manufacture of microelectronic circuits. At the 0.18-micrometer design rule, 80 of the approximately 400 total processing steps are cleaning steps. Wafers typically are cleaned after every contaminating process step and before each high temperature operation to ensure the quality of the circuit. Exemplary cleaning and removal applications include photoresist stripping/removal, particle/residue removal for post-chemical mechanical planarization (post-CMP cleaning), particle/residue removal for post-dielectric etching (or post-metal etching), and removal of metal contaminants.

Numerous cleaning methods have been used in the manufacture of semiconductor electronic components. These include immersion in liquid cleaning agents to remove contamination through dissolution and chemical reaction. Such immersion may also serve to reduce the van der Waals adhesive forces and introduce double layer repulsion forces, thereby promoting the release of insoluble particles from surfaces. One example of an immersion cleaning method is immersion in supercritical fluids. The effectiveness of supercritical fluids in various cleaning and extraction applications is well established and extensively documented. The solvency of supercritical fluids is much greater than the corresponding gaseous state; thus, supercritical fluids can effectively dissolve and remove unwanted films and molecular contaminants from a precision surface. The contaminants can be separated from the cleaning agent by a reduction in pressure below the critical value, which concentrates the contaminants for disposal and permits recovery and re-use of the cleaning fluid. However, in certain instances, the cleaning step may leave a residual non-volatile liquid additive in addition to or in lieu of the contaminant. This residual non-volatile additive should also be removed in order to reduce damage to underlying substrate surfaces before any subsequent processing steps are conducted.

### BRIEF SUMMARY OF THE INVENTION

A method for removing contaminants from an article is described herein. In one aspect, there is provided a method comprising:

(a) loosening at least a portion of the contaminants by treating the article with at least one treatment method selected from the following to provide a partially treated article comprising loosened contaminants: (i) treating the article with a dense processing fluid comprising a dense fluid, a co-solvent, a processing agent, a chelating agent, and optionally an entrainer to provide the partially treated article; (ii) treating the article with a processing fluid comprising the processing agent, optionally the co-solvent, optionally the chelating agent, and optionally the entrainer to provide the partially treated article; and (iii) treating the article with the processing fluid comprising, an processing agent, optionally the co-solvent, optionally the chelating agent, and optionally the entrainer and then treating the article with the dense processing fluid comprising the dense fluid, the co-solvent, the processing agent, the chelating agent, and optionally the entrainer to provide the partially treated article;

(b) optionally contacting the partially treated article with a dense rinse fluid comprising a dense fluid, optionally a co-solvent, and optionally an entrainer to remove liquid-based contaminants;

(c) removing at least a portion of the loosened contaminants by exposing the partially treated article with at least one exposure method selected from the following to provide a treated article: (i) exposing the partially treated article to a final processing fluid comprising a dense fluid component and optionally a solvent wherein the final processing fluid is a state selected from a supercritical or a subcritical fluid state provided that the loosened contaminants are wet; (ii) exposing the partially treated article to the final processing fluid and an agitation source provided that the loosened contaminants are wet; (iii) exposing the partially treated article to the final processing fluid wherein the final processing fluid is delivered to the surface through a plurality of fluid nozzles at a temperature and pressure sufficient to remove the loosened contaminants provided that the loosened contaminants are wet; (iv) exposing the partially treated article to an aerosol jet at a temperature and pressure sufficient to remove the loosened contaminants provided that the loosened contaminants are dry; and (v) exposing the partially treated article to a a cryogenic fluid and an agitation source provided that the loosened contaminants are dry; and

(d) restoring at least a portion of the surface of the treated and/or partially treated article by contacting the article with a mixture comprising an active agent.

In yet another aspect of the present invention, there is provided a method for removing contaminants from an article comprising:

(a) loosening at least a portion of the contaminants by treating the article with a treatment method selected from the following to provide a partially treated article comprising loosened contaminants: (i) treating the article with a dense processing fluid comprising a dense fluid, a co-solvent, a processing agent, a chelating agent, and optionally an entrainer to provide the partially treated article; (ii) treating the article with a processing fluid comprising the processing agent, optionally the co-solvent, optionally the chelating agent, and optionally the entrainer to provide the partially treated article; and (iii) treating the article with the processing fluid comprising, an processing agent, optionally the co-solvent, optionally the chelating agent, and optionally the entrainer and then treating the article with the dense processing fluid comprising the dense fluid, the co-solvent, the processing agent, the chelating agent, and optionally the entrainer to provide the partially treated article;

(b) contacting the partially treated article with a dense rinse fluid comprising a dense fluid, optionally a co-solvent, and optionally an entrainer to remove liquid-based contaminants;

(c) removing at least a portion of the loosened contaminants by exposing the partially treated article with at least one exposure method selected from the following to provide a treated article: (i) exposing the partially treated article to a final processing fluid comprising a dense fluid component and optionally a solvent wherein the final processing fluid is a state selected from a supercritical or a subcritical fluid state provided that the loosened contaminants are wet; (ii) exposing the partially treated article to the final processing fluid and the agitation source provided that the loosened contaminents are wet; (iii) exposing the partially treated article to the final processing fluid wherein the final processing fluid is delivered to the surface through a plurality of fluid nozzles at a temperature and pressure sufficient to remove the loosened contaminants provided that the loosened contaminents are wet; (iv) exposing the partially treated article to an aerosol jet at a temperature and pressure sufficient to remove the loosened contaminants provided that the loosened contaminants are dry; and (v) exposing the partially treated article to a cryogenic liquid and the agitation source provided that the loosened contaminants are dry.

### BRIEF DESCRIPTION OF SEVERAL VIEWS OF THE DRAWINGS

FIG. 1a is an exemplary article that may be cleaned using one embodiment of the method described herein.

FIG. 1b is an exemplary article that may be cleaned using one embodiment of the method described herein.

FIG. 2 is a process flow diagram illustrating an embodiment of the method described herein.

FIG. 3 is a pressure-temperature phase diagram for a single component supercritical fluid.

FIG. 4 is a density-temperature phase diagram for carbon dioxide.

FIG. 5 is a generalized density-temperature phase diagram.

### DETAILED DESCRIPTION OF THE INVENTION

A multi-step method for the removal of contaminants from an article is disclosed herein. The method includes the steps of loosening and then removing the loosened contaminants from the surface of an article. Typical contaminants to be removed from these articles in a cleaning process may include, for example, residues from manufacturing process steps such as lithography, etching, stripping, and chemical mechanical planarization (CMP); particulates either indigenous to and/or resulting from manufacturing processes; inorganic particulates or materials such as native or chemical oxides, and metal-containing compounds; or other sources and the contaminants can be further identified as chemically reactive, chemically non-reactive, permeable, and/or impermeable materials. These contaminants may be present in the form of particulates, films, and/or molecules. Examples of chemically resistant contaminants may include photoresist, anti-reflective coatings, various post-ash and post-etch residues, process-generated particles, and/solder flux residue.

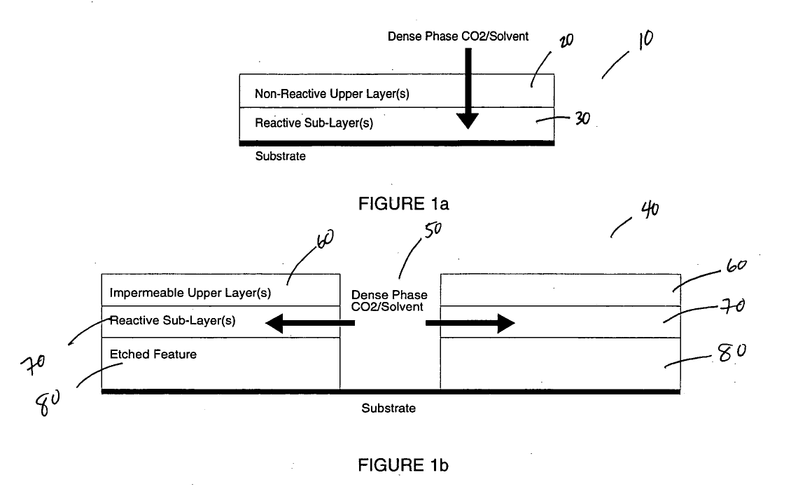

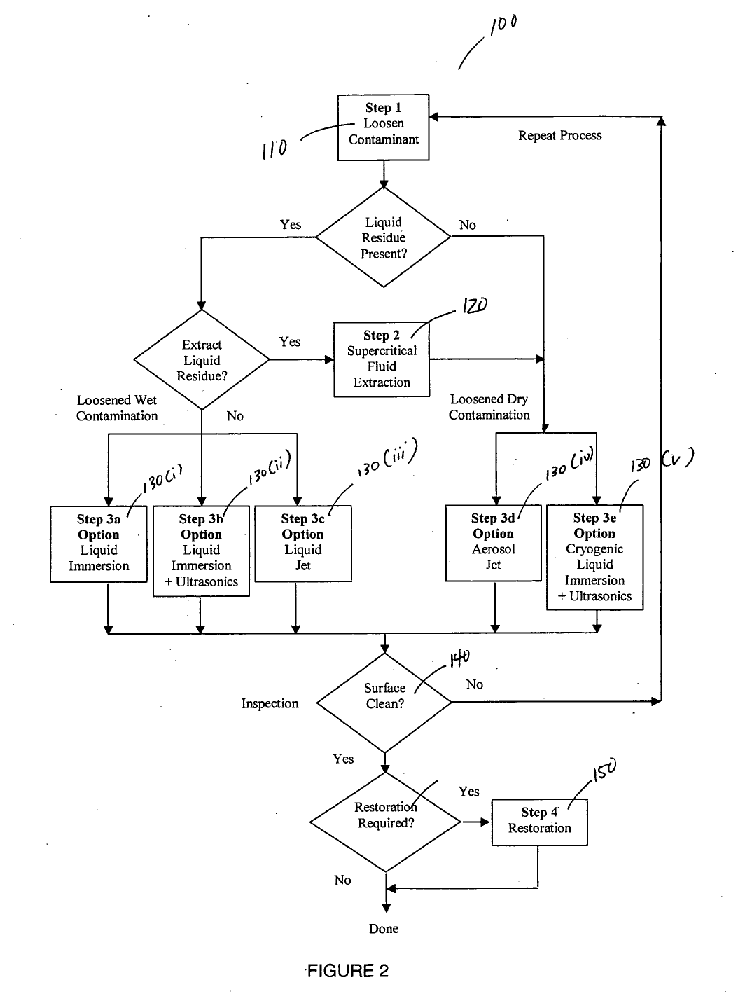

The contaminants to be loosened and subsequently removed may be particularly resistant to typical cleaning processes. In one embodiment, article 10 having contaminants may be comprised of, for example, of a non-reactive cross-linked or process-hardened upper layer 20 and photo-resist reactive sub-layer 30 (see FIG. 1a). In another embodiment, article 40 having contaminants may be a layered article having one or more topographical features 50 (e.g., vias, trenches, MEMS structures, etc.), a relatively impermeable upper layer (i.e., impermeable with regard to a dense or other fluid) 60, a reactive sub-layer 70, and an etched feature 80 (see FIG. 1b). In certain embodiments, the method described herein may further include a step for removing liquid-based contaminants from the surface. These liquid-based contaminants may be inherent to the article and/or may result from the initial loosening step.

The term “processing” or “processed” as used herein means contacting an article with a processing fluid or dense processing fluid to effect physical and/or chemical changes to the article. The term “article” as used herein means any article of manufacture wherein at least a portion of the surface has contaminants adhered thereto. Such articles may include, for example, silicon wafers or wafers made from compound semiconductor materials such as gallium arsenide, indium phosphide, silicon-germanium and the like, printed circuit boards, surface mounted assemblies, flip chip assemblies, electronic assemblies, and other related articles subject to contamination during fabrication. In one particular embodiment, the article may contain pores such as, for example, a porous low dielectric material, or other topographical features.

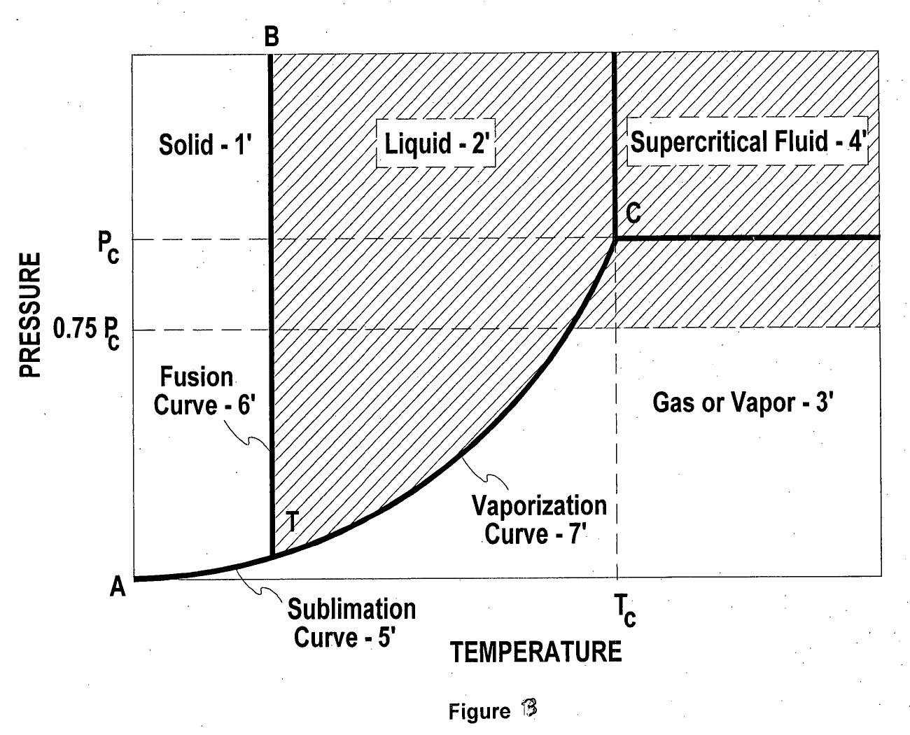

FIG. 2 provides an illustration of one embodiment of the method 100 described herein. In Step 110, the article is treated by using one or more treatment methods involving a processing fluid, a dense processing fluid, or combinations thereof to provide a partially treated article having loosened contaminants. The term “partially treated article” refers to an article that has been treated using one or more treatment methods. In step 110, the loosening process may occur near the plane of contact or point of contact of the contaminant and the article surface. These planes or points of contact are herein referred to as the contaminant-article “interface”. The adhesion of the surface contaminant to the article surface may be weakened, for example, through chemical reaction, or swelling, softening and/or dissolution of the contaminant. This may occur within the bulk material of the contaminant, the article, or both. In step 110, at least one of the following may occur: any covalent bonding between the contaminant and article is broken, embedded contaminants are released through etching (i.e., removal of bulk material) of the article, contaminant, or both; and/or surface and interfacial energies are substantially reduced through reaction at the interface. The film or particle thereby becomes loosened from the substrate. In certain embodiments, an agitation source may be introduced during at least a portion of the treatment step. The term “agitation source” as used herein describes a source that may cause the fluid (i.e., dense processing fluid, dense rinse fluid, final processing fluid, etc.) to impact upon a surface of the article. Examples of agitation sources include, but are not limited to, fluid jets, brushes, spinning, ultrasonic energy, sonic energy, linear fluid flow impingement, circular fluid flow impingement, and combinations thereof.

In certain embodiments, contaminant loosening step 110 may leave residual liquid-based contaminants, such as, for example, processing agents, chelating agents, co-solvents, and/or entrainers on the surface. In certain instances, these liquid-based contaminants may result from the dense processing fluid and/or processing fluid used in loosening step 110. To remedy this, optional step 120 may be conducted to remove these liquid-based contaminants. In step 120, the partially treated article is contacted with a dense rinse fluid to partially or completely remove the liquid-based contaminants. As a result, the liquid-based contaminants located on the surface are completely or partially removed during this step.

In step 130, the loosened contaminants are subsequently removed using one or more exposure methods to provide a treated article. The selection of exposure method in step 130 depends upon whether the loosened contaminants are wet or dry. In this regard, certain exposure methods may cause the loosened contaminants to adhere—rather than be removed—from the surface if the wrong exposure method is selected. In embodiments wherein the surface contains loosened liquid-based contaminants, the partially treated article is exposed to a final process fluid that may be administered through direct exposure, exposure in combination with one or more agitation sources, and/or exposure through a plurality of fluid nozzles at a certain temperature and pressure. In alternative embodiments wherein the surface contains loosened dry contaminants, the partially treated article is exposed to an aerosol jet and/or a cryogenic fluid in combination with one or more agitation sources.

After step 130 is completed, in step 140 the treated article is inspected via visual inspection, un-magnified visual inspection, optical microscopy, scanning electron microscopy (SEM), electrical inspection such as resistivity, conductivity, current leakage or other measurements, or similar means to determine the amount, if any, of remaining contaminants. If any contaminants remain, the article is subjected to steps 110, optional step 120, and 130 to further loosen and remove the remaining contaminants. The method is concluded when the initial contaminants are removed from the article surface to an extent sufficient to provide economical device yields upon completion of the multi-step fabrication process. In certain embodiments, the method is concluded when at least 95% or greater or at least 99% or greater of the initial contaminants are removed.

In embodiments wherein the article has certain topographical features and/or pores, the article may need to be subjected to restoration step 150. In these embodiments, it may be necessary to restore the integrity of the cleaned article by contacting the article with a mixture comprising one or more active agents prior to further processing. For example, in embodiments wherein the article contains low-k dielectric porosity, the article may be restored by contacting the article with a mixture comprising active agents such as the silylating agents trimethylchlorosilane (TMCS), trimethylsilane (TMS), hexamethyidisilazane (HMDS), and the like. The mixture can be applied directly as a liquid, vapor, or, alternatively, it can be dissolved in liquid or dense fluid solvents. In certain embodiments, a two-step process can be employed where bulk restoration and article treatment is achieved using a liquid phase mixture of active agent(s) and followed by treatment with an active agent dissolved in a dense fluid that penetrates the pores and restores the integrity of the article. Restoration step 150 can be carried out after all the contaminants have been removed and/or in conjunction with steps 110, 120 and/or 130.

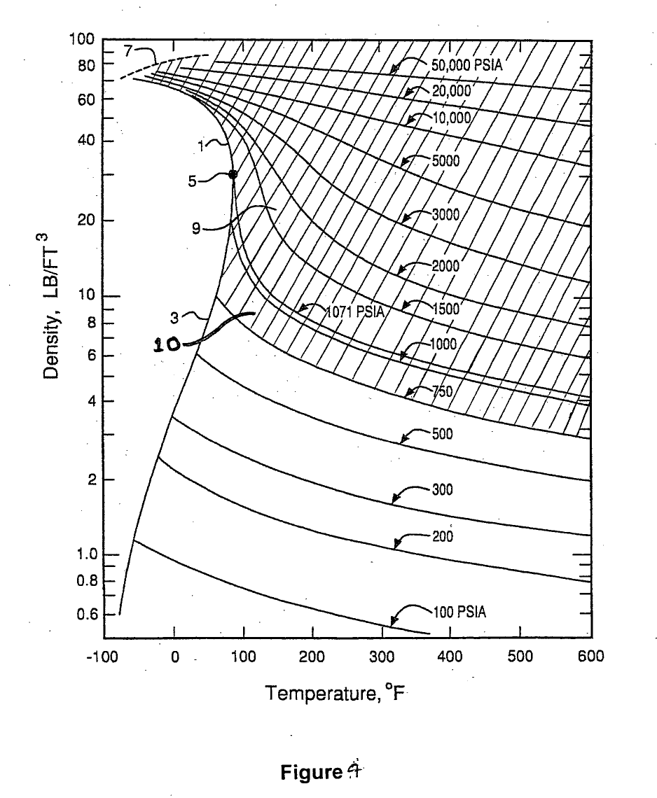

As mentioned previously, a dense processing fluid may be used in certain embodiments of the treatment method to loosen contaminants from an article and provide a partially treated article. In addition, in certain embodiments, the partially treated article may be contacted with a dense rinse fluid to remove at least a portion of the liquid-based contaminants. FIG. 3 is a pressure-temperature phase diagram for a single component dense fluid. The term “component” as used herein means an element (for example, hydrogen, helium, oxygen, nitrogen) or a compound (for example, carbon dioxide, methane, nitrous oxide, propane). Referring to FIG. 3, four distinct regions or phases, solid 1′, liquid 2′, gas 3′, and supercritical fluid 4′, exist for a single component. The critical point, designated “C” in FIG. 3, is defined as that pressure (critical pressure P_{c}) and temperature (critical temperature T_{c}) below which a single component can exist in vapor/liquid equilibrium. The density of the single component at the critical point is its critical density. Also shown in FIG. 3 are the sublimation curve 5′, or the line between “A” and “T” which separates the solid 1′ and gas 3′ regions, the fusion curve 6′, or the line between “T” and “B” which separates the liquid 2′ and solid 1′ regions, and the vaporization curve 7′, or the line between “T” and “C” which separates the liquid 2′ and gas 3′ regions. The three curves meet at the triple point, designated “T”, wherein the three phases, or solid, liquid and gas, coexist in equilibrium. A phase is generally considered a liquid if it can be vaporized by reducing pressure at constant temperature. Similarly, a phase is considered a gas if it can be condensed by reducing the temperature at a constant pressure. The gas and liquid regions become indistinguishable at or above the critical point C, as shown in FIG. 3.

A single-component supercritical fluid is defined as a fluid at or above its critical temperature and pressure. A related single-component fluid having similar properties to the single-component supercritical fluid is a single-phase fluid, which exists at a temperature below its critical temperature and a pressure above its liquid saturation pressure. An additional example of a single-component dense fluid may be a single-phase fluid at a pressure above its critical pressure or a pressure above its liquid saturation pressure. A single-component subcritical fluid is defined as a fluid at a temperature below its critical temperature or a pressure below its critical pressure or alternatively a pressure P in the range 0.75 P_{c}≦P≦P_{c} and a temperature above its vapor saturation temperature. In the present disclosure, the term “dense fluid” as applied to a single-component fluid is defined to include a supercritical fluid, a single-phase fluid which exists at a temperature below its critical temperature and a pressure above its liquid saturation pressure, a single-phase fluid at a pressure above its critical pressure or a pressure above its liquid saturation pressure, and a single-component subcritical fluid. An example of a single component dense fluid is shown as the thatched region in FIG. 3.

A dense fluid alternatively may comprise a mixture of two or more components. A multi-component dense fluid differs from a single-component dense fluid in that the liquid saturation pressure, critical pressure, and critical temperature are functions of composition. In this case, the dense fluid is defined as a single-phase multi-component fluid of a given composition which is above its saturation or bubble point pressure, or which has a combination of pressure and temperature above the mixture critical point. The critical point for a multi-component fluid is defined as the combination of pressure and temperature above which the fluid of a given composition exists only as a single phase. In the present disclosure, the term “dense fluid” as applied to a multi-component fluid is defined to include both a supercritical fluid and a single-phase fluid that exists at a temperature below its critical temperature and a pressure above its bubble point or saturation pressure. A multi-component dense fluid also can be defined as a single-phase multi-component fluid at a pressure above its critical pressure or a pressure above its bubble point or liquid saturation pressure. A multi-component dense fluid can also be defined as a single-phase or multi-phase multi-component fluid at a pressure P in the range 0.75 P_{c}≦P≦P_{c}, and a temperature above its bubble point or liquid saturation temperature. A multi-component subcritical fluid is defined as a multi-component fluid of a given composition, which has a combination of pressure and temperature below the mixture critical point.

The generic definition of a dense fluid thus includes a single component dense fluid as defined above as well as a multi-component dense fluid as defined above. Similarly, a subcritical fluid may be a single-component fluid or a multi-component fluid. In some embodiments, a single-component subcritical fluid or a multi-component subcritical fluid may be a dense fluid.

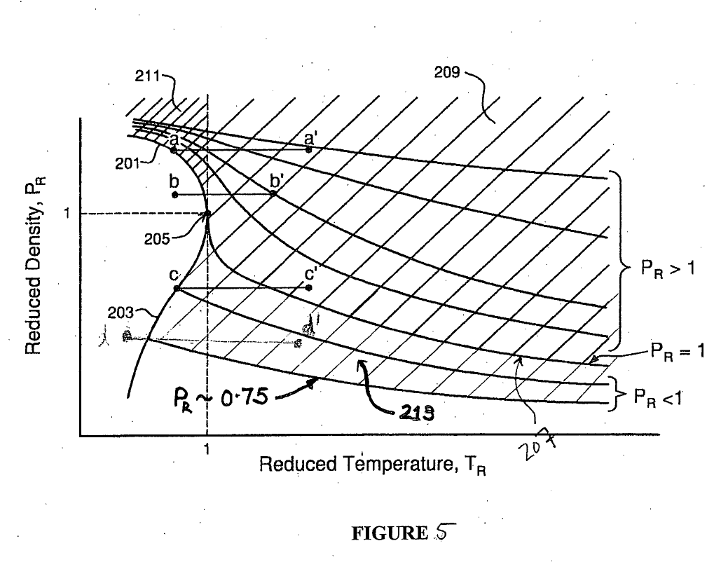

An example of a dense fluid for a single component is illustrated in FIG. 4, which is a representative density-temperature phase diagram for carbon dioxide. This diagram shows saturated liquid curve 1 and saturated vapor curve 3, which merge at critical point 5 at the critical temperature of 87.9° F. and critical pressure of 1,071 psia. Lines of constant pressure (isobars) are shown, including the critical isobar of 1,071 psia. Line 7 is the melting curve. The region to the left of and enclosed by saturated liquid curve 1 and saturated vapor curve 3 is a two-phase vapor-liquid region. The region outside and to the right of liquid curve 1, saturated vapor curve 3, and melting curve 7 is a single-phase fluid region. The dense fluid as defined herein is indicated by crosshatched regions 9 (at or above critical pressure) and 10 (below critical pressure).

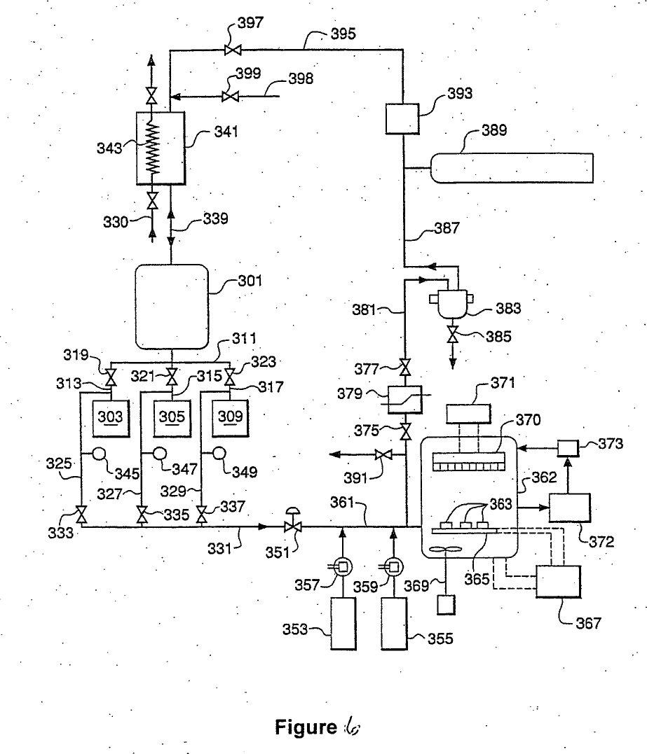

A generic density-temperature diagram can be defined in terms of reduced temperature, reduced pressure, and reduced density as shown in FIG. 5. The reduced temperature (T_{R}) is defined as the absolute temperature divided by the absolute critical temperature, reduced pressure (P_{R}) is defined as the absolute pressure divided by the absolute critical pressure, and reduced density (ρ_{R}) is defined as the density divided by the critical density. The reduced temperature, reduced pressure, and reduced density are all equal to 1 at the critical point by definition. FIG. 5 shows analogous features to FIG. 4 including saturated liquid curve 201 and saturated vapor curve 203, which merge at critical point 205 at a reduced temperature of 1, a reduced density of 1, and a reduced pressure of 1. Lines of constant pressure (isobars) are shown, including critical isobar 207 for which P_{R}=1. In FIG. 5, the region to the left of and enclosed by saturated liquid curve 201 and saturated vapor curve 203 is the two-phase vapor-liquid region. The crosshatched region 209 above the P_{R}=1 isobar and to the right of the critical temperature T_{R}=1 is a single-phase supercritical fluid region. The crosshatched region 211 above saturated liquid curve 201 and to the left of the critical temperature T_{R}=1 is a single-phase compressed liquid region. The cross-thatched region 213 to the right of saturated vapor curve 203, and below the isobar P_{R}=1 represents a single-phase compressed or dense gas. The dense fluid as defined herein includes single-phase supercritical fluid region 209, single-phase compressed liquid region 211, and the single-phase dense gas region 213.

The generation of a dense fluid used in certain embodiments may be illustrated using FIG. 5. In one embodiment, a saturated liquid at point a is introduced into a vessel and sealed therein. The sealed vessel is heated isochorically, i.e., at essentially constant volume, and isopycnically, i.e., at essentially constant density. The fluid moves along the line as shown to point a′ to form a supercritical fluid in region 209. This is generically a dense fluid as defined above. Alternatively, the fluid at point a may be heated to a temperature below the critical temperature (T_{R}=1) to form a compressed liquid. This also is a generic dense fluid as defined above. In another embodiment, a two-phase vapor liquid mixture at point b is introduced into a vessel and sealed therein. The sealed vessel is heated isochorically, i.e., at essentially constant volume, and isopycnically, i.e., at essentially constant density. The fluid moves along the line as shown to point b′ to form a supercritical fluid in region 209. This is generically a dense fluid as defined above. In another embodiment, a saturated vapor at point c is introduced into a vessel and sealed therein. The sealed vessel is heated isochorically, i.e., at essentially constant volume, and isopycnically, i.e., at essentially constant density. The fluid moves along the line as shown to point c′ to form a supercritical fluid in region 209. This is generically a dense fluid as defined above. In yet another embodiment an unsaturated vapor at point d is introduced into a vessel and sealed therein. The sealed vessel is heated isochorically, i.e., at essentially constant volume, and isopycnically, i.e., at essentially constarit density. The fluid moves along the line as shown to point d′ to form a dense gas in region 213. This is generically a dense fluid as defined above.

The final density of the dense fluid is determined by the volume of the vessel and the relative amounts of vapor and liquid originally introduced into the vessel. A wide range of densities thus is achievable by this method. The terms “essentially constant volume” and “essentially constant density” mean that the density and volume are constant except for negligibly small changes to the volume of the vessel that may occur when the vessel is heated.

Depending upon the application, the dense fluid may be either a single-component fluid or a multi-component fluid, and may have a reduced temperature ranging from about 0.2 to about 2.0, and a reduced pressure above 0.75. The reduced temperature is defined here as the absolute temperature of the fluid divided by the absolute critical temperature of the fluid, and the reduced pressure is defined here as the absolute pressure divided by the absolute critical pressure.

In alternative embodiments, the dense fluid is provided by using a compressor, pump, or the like to bring the fluid to its supercritical state. The conditions that are needed to reach supercritical state may vary depending upon the one or more components contained within the dense fluid.

The dense fluid may comprise, but is not limited to, one or more dense fluid components selected from the group consisting of carbon dioxide, nitrogen, methane, oxygen, ozone, argon, hydrogen, helium, ammonia, nitrous oxide, hydrocarbons having 2 to 6 carbon atoms, hydrogen chloride, sulfur trioxide, and water.

In certain embodiments of the present invention, the dense processing fluid and/or the dense rinse fluid comprises one or more dense fluid components that are fluorinated, such as, but not limited to, perfluorocarbon compounds (e.g., tetrafluoromethane (CF₄) and hexafluoroethane (C₂F₆)), hydrofluorocarbons (e.g., difluoromethane (CH₂F₂), trifluoromethane (CHF₃), methyl fluoride (CH₃F), pentafluoroethane (C₂HF₅), trifluoroethane (CF₃CH₃), difluoroethane (CHF₂CH₃), and ethyl fluoride (C₂H₅F)), fluorinated nitriles (e.g., perfluoroacetonitrile (C₂F₃N) and perfluoropropionitrile (C₃F₅N)), fluoroethers (e.g., perfluorodimethylether (CF₃—O—CF₃), pentafluorodimethyl ether (CF₃—O—CHF₂), trifluoro-dimethyl ether (CF₃—O—CH₃), difluoro-dimethyl ether (CF₂H—O—CH₃), and perfluoromethyl vinyl ether (CF₂═CFO—CF₃)), fluoroamines (e.g., perfluoromethylamine (CF₅N)), and other fluorinated compounds such as nitrogen trifluoride (NF₃), carbonyl fluoride (COF₂), nitrosyl fluoride (FNO), hexafluoropropylene oxide (C₃F₆O₂), hexafluorodisiloxane (Si₂OF₆), hexafluoro-1,3-dioxolane (C₃F₆O₂), hexafluoropropylene oxide (C₃F₆O), fluoroxytrifluoromethane (CF₄O), bis(difluoroxy)methane (CF₄O₂), difluorodioxirane (CF₂O₂), trifluoronitrosylmethane (CF₃NO)), hydrogen fluoride, sulfur hexafluoride, chlorine trifluoride, hexafluoropropylene, hexafluorobutadiene, octafluorocyclobutane, tetrafluorochloroethane, and the like.

Further examples of fluorinated dense fluids include, but are not limited to, zeotropic and azeotropic mixtures of different refrigerants such as 507A (mixture of pentafluoroethane and trifluoroethane) and 410A (mixture of difluoromethane and pentafluoroethane). These fluorinated fluids are used either independently or in mixtures.

The one or more of the above fluorinated fluids may be added to the dense processing fluid and/or the dense rinse fluid in a liquid, gaseous, or supercritical state. In embodiments wherein the fluorinated fluid is used in its supercritical state, fluorinated fluids with a low critical temperature (T_{c}) and critical pressure (P_{c}) may be preferable. The normal boiling point temperatures (T_{b}), critical temperatures and critical pressures of some exemplary fluorinated dense fluids are provided in Table I.

TABLE I
Thermodynamic Properties of Select Fluorinated Solvents

| Solvent/Gas | Formula | T_{b} (° C.) | T_{c} (° C.) | P_{c} (bar) |
|---|---|---|---|---|
| Nitrogen trifluoride | NF₃ | −129.1 | −39.0 | 45.3 |
| Tetrafluoromethane | CF₄ | −127.9 | −45.4 | 37.4 |
| Trifluoromethane | CHF₃ | −82.1 | 26.3 | 48.6 |
| Hexafluoroethane | C₂F₆ | −78.2 | 20.0 | 30.6 |
| Pentafluoroethane | C₂HF₅ | −48.6 | 66.3 | 36.3 |
| Difluoromethane | CH₂F₂ | −51.8 | 78.6 | 58.3 |
| Methyl Fluoride | CH₃F | −78.4 | 42.0 | 56.0 |
| Trifluoroethane | C₂F₃H₃ | −47.2 | 72.7 | 37.6 |
| Refrigerant 507A | Mixture | −47.0 | 70.7 | 37.1 |
| Perfluoroethylene | C₂F₄ | −76.0 | 33.3 | 39.4 |
| Perfluoropropylene | C₃F₆ | −29.6 | 86.2 | 29.0 |
| Difluoroethylene | CF₂═CH₂ | −84.0 | 30.0 | 44.6 |
| Perfluoroacetonitrile | C₂F₃N | −64.5 | 38.0 | 36.2 |

A “dense processing fluid” is defined herein as a dense fluid to which one or more processing agents, one or more co-solvents, one or more chelating agents, and optionally one or more entrainers have been added. The dense processing fluid may be used in one or more treatment steps, for example, loosening of a variety of contaminants from the surface of the article. In certain embodiments, the dense processing fluid may be used in addition to, or in place of, a processing fluid in the treatment method. In embodiments wherein the dense processing fluid is used in addition to the processing fluid, the article is first treated with the processing fluid and then treated with the dense processing fluid. A “processing fluid” is defined herein as a mixture having one or more processing agents, optionally one or more solvents, optionally one or more co-solvents, optionally one or more chelating agents, and optionally one or more entrainers. The processing fluid differs from the dense processing fluid in that it is substantially free of a dense fluid.

The processing fluid and/or the dense processing fluid comprise one or more processing agents. A “processing agent” is defined herein as a compound or combination of compounds that promotes physical and/or chemical changes to an article or substrate when treated with the dense processing fluid and/or processing fluid. It can also enhance the cleaning ability of the dense processing fluid and/or processing fluid to loosen contaminants from a article surface. The total concentration of processing agent in the dense processing fluid and/or processing fluid typically is about 50 weight percent (“wt. %”) or less, or may range from about 0.01 to about 20 wt. % or from about 0.01 to about 10 wt. % or from about 0.01 to about 5 wt. %. In certain embodiments, the processing agent may be added in a solution which can be, for example, one of the dense fluid components and/or co-solvents provided herein. Examples of suitable processing agents include, but are not limited to, basic compounds such as quaternary ammonium hydroxide, ammonium hydroxide, an alkylamine, an alkanolamine, a hydroxylamine, and mixtures thereof. Further examples of processing agents include fluorides such as compounds having the formula NR₁R₂R₃R₄F, where R₁, R₂, R₃, and R₄ are each independently a hydrogen atom or an alkyl group. Examples of these fluorides include selected from ammonium fluoride (NH₄F), tetramethylammoniumfluoride (TMAF), tetraethylammoniumfluoride (TEAF), tetrabutylammoniumfluoride (TBAF), tetrapropylammoniumfluoride, choline fluoride, and mixtures thereof. Exemplary quaternary ammonium hydroxides include tetramethyl ammonium hydroxide (TMAH), tetraethylammonium hydroxide (TEAH), tetra-butyl-ammonium-hydroxide (TBAH), tetra-propyl-ammonium-hydroxide, and mixtures thereof.

In embodiments wherein the treatment is conducted using a dense processing fluid, the dense processing fluid typically remains a single phase after a processing agent is added to a dense fluid. In alternative embodiments, however, the dense processing fluid may be an emulsion or suspension containing a second suspended or dispersed phase containing the processing agent. In embodiments wherein the treatment is conducted using a processing fluid, the processing fluid may be applied directly to the substrate, such as for example, by spray coat, spin coat, or other means.

The dense processing fluid or processing fluid may comprises one or more co-solvents. The term “co-solvent” as used herein describes an agent that is used to enhance the solubility of the processing agent in the dense processing fluid and/or processing fluid. It may also enhance the solubility of the at least one processing agent, or combination of processing agents, in the dense processing fluid and/or processing fluid. In embodiments wherein a co-solvent is added to the dense processing fluid, the co-solvent is preferably at least one co-solvent selected from the group consisting of esters (ethyl acetate, ethyl lactate), ethers (diethyl ether, dipropyl ether diethyleneglycolmonomethylether, diethyleneglycolmonoethylether), alcohols (methanol, ethanol, n-propanol, isopropanol, n-butanol, iso-butanol, hexafluoroisopropanol), nitriles (acetonitrile, propionitrile, benzonitrile), hydrated nitriles (ethylene cyanohydrin), glycols (ethylene glycol, propylene glycol), glycol ethers (2-butoxy ethanol, dipropylene glycol methyl ether), monoester glycols (ethylene glycol monoacetate), ketones (acetone, acetophenone) and fluorinated ketones (trifluoroacetophenone), amides (dimethylformamide, dimethylacetamide), carbonates (ethylene carbonate, propylene carbonate), alkane diols (butane diol, propane diol), alkanes such as cyclopentane, heptane, n-hexane, n-butane), alkyl sulfoxide such as dimethyl sulfoxide (DMSO), alkyl acetamide such as dimethylacetamide, and mixtures thereof. Still other exemplary co-solvents include tertiary amines including pyridines (triethyl amine, tributyl amine, 2,4, dimethyl pyridine), alkanolamines (dimethylethanolamine, diethylethanolamine), amides (dimethylformamide, dimethylacetamide), carbonates (ethylene carbonate, propylene carbonate), carboxylic acids (acetic acid, tartaric acid, malic acid), alkane diols (butane diol, propane diol), alkanes (n-hexane, n-butane), peroxides (hydrogen peroxide, t-butyl hydroperoxide, 2-hydroperoxy hexafluoropropan-2-ol), water (deionized, ultrahigh purity), ureas, haloalkanes (perfluorobutane, hexafluoropentane), haloalkenes, and combinations thereof. The amount of co-solvent added to the dense processing fluid may range from 1 to 50 wt. %, or from 1 to 20 wt. %, or from 1 to 20 wt. %.

In formulations wherein a co-solvent is added to the dense processing fluid, the composition of the dense processing fluid comprises from 50 to 99 wt. % of dense fluid, from 1 to 20 wt. % of co-solvent, and from 0.01 to 10 wt. % of at least one processing agent. In one particular embodiment, the dense processing fluid comprises from 65 to 99 wt. % of a dense fluid such as liquid/supercritical CO₂, from 1 to 20 wt. % of a co-solvent such as an amide or DMSO, and from 0.01 to 15 wt. % of at least one processing agent such as TBAF or TMAH. In another embodiment the dense processing fluid comprises from 0.1 to 99 wt. % of a dense fluid such as liquid/supercritical CO₂, from 5 to 90 wt. % of a fluorinated dense fluid (e.g., supercritical hexafluoroethane), from 0.01 to 15 wt. % of at least one processing agent, and from 0 to 20 wt. % of a co-solvent. In yet another embodiment, the dense processing fluid comprises from 0.1 to 95 wt. % of a dense fluid such as liquid/supercritical CO₂, from 5 to 99.9 wt. % of a fluorinated dense fluid, from 0 to 40 wt. % of a co-solvent such as an amide or DMSO, and from 0.01 to 40 wt. % of at least one processing agent.

The dense processing fluid or processing fluid may comprises one or more chelating agents. The term “chelating agent” as used herein describes an agent that can bind and/or adhere to contaminants such as metal particles and ions to form complexes soluble in the dense processing fluid and/or processing fluid. Examples of suitable chelating agents include, but are not limited to, beta-diketones such as acetylacetone, acetonyl acetone, trifluoroacetylacetone, thenoyltrifluoroacetone, or hexafluoroacetylacetone, beta-ketoimines, carboxylic acids such as citric acid, malic acid, oxalic acid, or tartaric acid, malic acid and tartaric acid based esters and diesters and derivatives, a malic acid ester and/or diester, a tartaric acid ester and/or diester, an oxine such as 8-hydroxyquinoline, a tertiary amine such as 2-acetyl pyridine, a tertiary diamine, a tertiary triamine, a nitrile such as ethylene cyanohydrin, a beta-ketoimine, ethylenediamine tetraacetic acid and its derivatives, catechol, choline-containing compounds, trifluoroacetic anhydride, an oxime such as dimethyl glyoxime, dithiocarbamates such as bis(trifluoromethyl)dithiocarbamate, terpyridine, ethylene cyanohydrin, N-(2-hydroxyethyl) iminodiacetic acid, and combinations thereof. In one processing fluid may be a malic acid diester, a tartaric acid diester, or derivatives thereof. The amount of chelating agent added to the dense processing fluid or processing fluid may range from 0.01 to 20 wt. %, or from 1 to 5 wt. %.

The dense processing fluid or processing fluid may comprises one or more entrainers. The term “entrainer” as used herein describes an agent that enhances the cleaning ability of the dense fluid to remove contaminants from a contaminated substrate. Further, the entrainer may solubilize and/or disperse the contaminant within the dense cleaning fluid. Entrainers may comprise surfactants and other chemical modifiers. The amount of entrainer that may be added to the dense processing fluid or the processing fluid may range from 0.01 to 20 wt. %, or from 1 to 10 wt. %, or from 1 to 5 wt. %. Some examples of representative entrainers include acetylenic alcohols and derivatives thereof (such as derivatized or hydrogenated acetylenic alcohols), acetylenic diols (non-ionic alkoxylated and/or self-emulsifiable acetylenic diol surfactants) and derivatives thereof (such as derivatized or hydrogenated acetylenic diols), acids such as mild phosphoric acid, citric acid, sulfuric acid, hydrofluoroethers (HFE) that are liquid at room temperature such as methyl perfluorobutyl ether or HFE-449S1, HFE-7100, HFE-569SF2, HFE-7200, HFE-7500, HFE-7000 provided by 3M™, alkyl alkanolamines such as diethylethanol amine, and alkalis such as potassium hydroxide. In one embodiment, the entrainer may consist of one or more compounds that may be termed an amine-epoxide adducts or derivatives thereof. These compounds may be formed by end-capping diamines, triamines and/or tetramines such as, but not limited to, ethylene diamine-(EDA), diethyl triamine (DETA), and triethyltriamine (TETA) with alkyl glycidyl ethers such as, but not limited to, n-butyl glycidyl ether (Epodil™741). Some examples of amine-epoxide adduct compounds are disclosed in U.S. Pat. Nos. 6,656,977 and 6,746,623, which are assigned to the assignee of this invention and incorporated herein by reference in their entirety. These adducts are typically straw-colored or colorless liquids that are mildly corrosive with a pH that ranges from 8 to 11. Additional amine epoxide adduct compounds are provided in the following Table II:

TABLE II
Examples of Amine-Epoxide Adduct Surfactants

| | |
|---|---|
| DETA/5E741 | Diethylenetriamine capped with 5 molecules of EPODIL ™ 741 (n- |
| | butyl-glycidyl ether) |
| DETA/5IBGE | Diethylenetriamine capped with 5 molecules of isobutyl-glycidyl ether |
| DETA/5EHGE | Diethylenetriamine capped with 5 molecules of EPODIL ™ 746 (ethyl- |
| | hexyl glycidyl ether) |
| DETA/5E748 | Diethylenetriamine capped with 5 molecules of EPODIL ™ 748 (n |
| | dodecyl glycidyl ether) |
| TETA/6BGE | Triethylenetetramine capped with 6 molecules of isobutyl-glycidyl |
| | ether |
| EDA/4BGE | Ethylenediamine capped with 4 moles of n-butyl glycidyl ether |
| EDA/4IBGE | Ethylenediamine capped with 4 moles of isobutyl glycidyl ether |
| EDA/4EHGE | Ethylenediamine capped with 4 moles of ethyl hexyl glycidyl ether |
| DAPA/5BGE | Di-aminopropylamine capped with 5 moles of EPODIL ™ 741 (n-butyl |
| | glycidyl ether) |
| HMDA/4BGE | Hexamethylenediamine capped with 4 moles of EPODIL ™ 741 (n- |
| | butyl glycidyl ether) |
| DAPDEG/4BGE | Di-aminopropylated diethylene glycol capped with 4 moles of |
| | EPODIL ™ 741 (n-butyl glycidyl ether) |
| PACM/4BGE | Bis(para-aminocyclohexyl)methane capped with 4 moles of EPODIL ™ |
| | 741 (n-butyl glycidyl ether) |

The following Table III provides exemplary dense processing fluid formulations for various article treatment applications depending upon the nature of the contaminant that needs to be loosened:

TABLE III
Exemplary Dense Processing Fluids for Various Article Treatment Applications

| | Exemplary | | | | Processing |
|---|---|---|---|---|---|
| Application | Contaminants | Dense Fluid | Co-solvent | Entrainers | Agent |
| Post-etch | Fluoropolymers, | Liquid or | Nitriles, | Surfynol ®61, | Quaternary |
| cleaning | organometallic | Supercritical | Alcohols, | Surfynol ®420, | ammonium |
| (metals) | species, metal | CO₂ | Tertiary amines, | Dynol ®604, | hydroxides, |
| | particles | Supercritical | Aprotic solvents | Hydrogenated | Alkanolamines, |
| | | C₂F₆ | such as | Surfynol ®104, | Tertiary amines, |
| | | | dimethylacetamide | Dibutyl malate, | Hydroxylamines, |
| | | | alkyl sulfoxide | Dipentyl | Alkyl |
| | | | | tartrate | Ammonium |
| | | | | | fluorides |
| Post-etch | Fluoropolymers, | Liquid or | Nitriles | Surfynol ®61, | Quaternary |
| cleaning | hardened | Supercritical | Alcohols | Surfynol ®420, | ammonium |
| (polymers) | organic polymer | CO_{2,} | Aprotic solvents | Dynol ®604 | hydroxides, |
| | | Supercritical | such as | Hydrogenated | Alkanolamines, |
| | | C₂F₆ | dimethylacetamide | Surfynol ®104 | Tertiary amines, |
| | | | alkyl sulfoxide | | Hydroxylamines, |
| | | | | | Alkyl |
| | | | | | Ammonium |
| | | | | | fluorides |
| Photoresist | Organic polymer | Liquid or | Nitriles, | Surfynol ®61, | Quaternary |
| removal/strip | residue, | Supercritical | Acetophenone, | Surfynol ®420, | ammonium |
| ping | fluoropolymers | CO₂ | Alcohols, | Dynol ®604 | hydroxides |
| | | | Aprotic solvents | Hydrogenated | Alkanolamines, |
| | | | such as | Surfynol ®104 | Tertiary amines, |
| | | | dimethylacetamide | | Hydroxylamines, |
| | | | alkyl sulfoxide | | Ammonium |
| | | | | | fluorides |
| Ash residue | Oxidized carbon | Liquid or | Tertiary amines, | Surfynol ®61, | Quaternary |
| removal | residue, organic | Supercritical | Nitriles, | Surfynol ®420, | ammonium |
| | polymer or | CO₂ | Alcohols, | Dynol ®604 | hydroxides, |
| | fluoropolymer | | Aprotic solvents | Hydrogenated | Alkanolamines, |
| | residue, | | such as | Surfynol ®104 | Tertiary amines, |
| | oxidized metallic | | dimethylacetamide | Dibutyl malate | Hydroxylamines, |
| | residue | | alkyl sulfoxide | Dipentyl | Ammonium |
| | | | | tartrate | fluorides |

As mentioned previously, the contaminants are loosened from the surface of an article by treating the article with one of the following treatment methods that involves the dense processing fluid and/or the processing fluid to provide a partially treated article. In the first treatment method, the article is treated with a dense processing fluid alone to loosen at least a portion of the contaminants. Depending upon the embodiment, at the end of the loosening step, the dense processing fluid is removed from contact with the surface. This removal may be accomplished through displacement of the dense processing fluid with a dense phase pure fluid. Alternatively, the dense processing fluid may be simply vented from the processing chamber containing the substrate.

In the second treatment method, the article is treated with a processing fluid. In these embodiments, the processing fluid may be applied to the article surface by spraying, spin-coating or other means. In these embodiments, the processing fluid and any loosened contaminants may be removed by purging the process chamber with a dense fluid and/or dense rinse fluid. These embodiments may be suitable if, for example, the processing agent may be insoluble in the dense processing fluid and/or dense rinse fluid.

In the third treatment method, the article is treated using both the processing fluid and the dense processing fluid. In this embodiment, the article is first treated with the processing fluid and then treated with a dense processing fluid. This second treatment step with the dense processing fluid may be needed, for example, to loosen contaminants in regions where the processing fluid may not have easy access or egress. This later treatment method may be particularly suitable for articles having high aspect ratio trenches and deep vias (holes) through multiple metal layers.

For example, the third treatment method can be used to loosen and contaminants for many different applications including: post-etch contaminant removal and post-ash contaminant removal. In post-etch contaminant removal, the contaminants consist of etched photoresist, underlying bottom anti-reflective coating (BARC), and post-etch polymer and organometallic films in high aspect ratio trenches and vias. In the first step, an etched substrate is first treated with a processing fluid to loosen photoresist and bottom anti-reflective coating (BARC) films. By using suitable processing conditions of temperature, concentration, agitation and the like, a substantially large part of the photoresist and BARC residue is swollen, undercut, dislodged or loosened, without damaging the substrate. In the second step, the dense processing fluid is used to dislodge residual photoresist and BARC contaminants and clean the polymer and organometallic residue in the high aspect ratio trenches and deep vias. The second step uses a minimal quantity of processing agent, co-solvent and/or entrainer, and is yet able to penetrate and dislodge/loosen contaminants from regions that the processing fluid is unable to reach. In still other embodiments, rapid depressurization of the dense processing fluid can dislodge any residual hardened photoresist or BARC from the substrate thereby allowing aiding its removal in subsequent processing steps. Suitable processing agents used may include organic fluoride salts and/or quaternary ammonium hydroxides and co-solvents used may include organic amine-based solvents.

In post-ash contaminant removal, the contaminants consist primarily of oxidized polymer films and/or oxidized organometallic films and particles, and are present both on the substrate surface and in high aspect ratio trenches and deep vias. In the first step, the processing fluid penetrates, swells, and loosens the adhesion between ashed polymeric films and the substrate. Chelating agents within the processing fluid, entrain metallic particles and ions and form metallic complexes. In the second step, a dense processing fluid is used to dislodge the swollen polymer film and the entrained metallic species. Processing agents used may include organic fluoride salts and/or quaternary ammonium hydroxides and co-solvents used may include organic amine-based solvents, or peroxides.

In certain embodiments, process enhancements such as one or more agitation sources may be used in these loosening steps to increase the rates of mass transport and chemical reaction at the surface. Other process enhancements such as dense fluid jets containing processing agents and/or entrainers directed at the contaminated surface may also be used to partially or fully remove loosened contaminants during the loosening step using fluid dynamic force. However, in the absence of such externally applied agitation sources such as fluid dynamic force, ultrasonic energy and the like, the loosened contaminants may remain in place on the surface following this step.

In certain embodiments, the article or partially treated article is optionally contacted with a dense rinse fluid to remove at least a portion of the loosened, liquid-based contaminants. The dense rinse fluid removes any loosened residual liquid-based contaminants that remain on the partially treated article and/or may have been introduced from contact with the dense processing fluid and/or processing fluid. The dense rinse fluid may be comprised of any of the dense fluid components disclosed herein, optionally a co-solvent such as any of the co-solvents disclosed herein, and optionally an entrainer such as any of the entrainers disclosed herein. The article or partially treated article may be contacted with the dense rinse fluid after and/or during at least a portion of the time that the article is contacted with the dense processing fluid and/or processing fluid. In either embodiment, the dense rinse fluid may be applied to the article at substantially the same process and temperature as the dense processing fluid. Further, the step, of contacting the article or partially treated article with the dense rinse fluid, may be performed in the same processing chamber or a different processing chamber.

The loosened contaminants are then removed from the partially treated articles using one or more exposure methods. The exposure method used depends on whether the loosened contaminants are in a wet or dry condition. In embodiments wherein the loosened contaminants are wet, the partially treated article is exposed to a final processing fluid. The final processing fluid may comprise one or more of the dense fluid components described herein in a subcritical or supercritical fluid state, optionally a co-solvents such as any of the co-solvents described herein, and optionally a surfactant such as any of the surfactants disclosed herein or other surface-active agents. Examples of a suitably dense fluid component that may be used in the final processing fluid include liquid (subcritical state) or supercritical (dense) CO₂ or H₂O. Exemplary co-solvents include an alcohol such as ethanol or methanol. In alternative embodiments, the final processing fluid may comprise a co-solvent having suitably low surface tension. In the first exposure method, the partially treated article may be exposed to a final processing fluid having sufficient surface tension to effectively dislodge the loosened contaminants. For example, carbon dioxide in a subcritical state has a surface tension of approximately 1 dyne/cm compared to a corresponding value of approximately 72 dynes/cm for water. Such high volatility produces negligible residue on the cleaned substrate and eliminates film property degradation known to occur for some dielectric materials following exposure to aqueous media.

In the second exposure method, the partially treated article is exposed to the final processing fluid while subjected to at least one agitation source. In this embodiment, the intensity of ultrasonic waves should be sufficient to effect cavitations and/or substantial acoustic streaming in the liquid medium. Cavitations dislodge the loosened contaminants through energy released during implosion of unstable bubbles, and acoustic streaming releases contaminants through hydrodynamic shear forces produced by convective fluid flow. Examples of suitable final processing fluids that are suitable for these embodiments may comprise the components include water and liquid CO₂ in a subcritical state and optionally a co-solvent such as the alcohol ethanol. The degree of surface damage resulting from exposure to bubble implosions may be controlled through the use of low intensity waves and/or high frequencies (megasonics). Selection of the component within the final processing fluid having relatively low surface tension (such as liquid CO₂), or the use of surfactants to reduce surface tension also reduces the size of bubbles and the resulting damage.

In the third exposure method, the final processing fluid is introduced to the partially treated article using a plurality of fluid jets. In this embodiment, the viscosity, density and velocity of the final processing fluid should be sufficient to effect dislodgement of the loosened contaminants though application of certain forces such hydrodynamic shear. Final processing fluids containing any one of the dense fluid components in a subcritical state, optionally a co-solvent, and optionally a surfactant. In one embodiment, a suitable fluid jet may consist of a single nozzle or multiple nozzles arranged in a regular pattern and directed toward the article surface. Such nozzles may have diameters that range, for example, from 1 mm to 10 mm, may be positioned, for example, from 1 mm to 50 mm from the article surface, and may be oriented, for example, at an angle ranging from 10 degrees to 90 degrees with respect to the article surface. The flow rate of liquid from the fluid nozzle may range from 1 ml/minute to 1000 ml/minute, depending upon the desired velocity of flow to be directed at the loosened contaminant. In certain embodiments, the article may be moved relative to the fluid nozzles in order to affect complete and uniform exposure of the substrate to the fluid dynamic removal force provided by the fluid jet(s). In one particular embodiment, a typical nozzle would be 1.6 mm in diameter, oriented 45 degrees with respect to the article surface, and located at a distance of 38 mm from the surface. In this embodiment, the nozzle may emit 50 ml/minute of liquid CO₂ at a pressure of 1000 psi, and a temperature of 20° C. toward the loosened contamination. However, other fluid nozzle sizes, orientations, and distances may be suitable depending upon such factors as the size and geometry of the article, the nature of the loosened contaminant, etc.

In embodiments wherein the loosened contaminants are dry, the partially treated article may be exposed to aerosol jet cleaning and/or cryogenic liquid immersion combined with ultrasonics. This is because residual liquid-based contaminants may freeze under the low temperatures of the aerosol jets and/or cryogenic fluids and thereby increase the adhesion of contaminants to surfaces. In the fourth exposure method, the article surface is exposed to aerosol jets. In this method, suitable aerosol jets may be formed from Ar/N₂ mixtures, Ar, CO₂ or other media to remove loosely adhering surface contaminants. The loosened contaminants are removed following impact with aerosol projectiles having sufficient kinetic energy to overcome the adhesive energies of the contaminants. In certain embodiments, removal of loosened contamination can be effected following approximately 10 seconds of exposure to this process step for each point on the substrate. In the fifth exposure method, the article is exposed to a cryogenic fluid immersion combined with an agitation source such ultrasonics. Suitable cryogenic fluids that may be used are, for example, liquefied atmospheric gases that exhibit one or more of the following characteristics: low surface tension, chemical non-reactivity, low cost, and/or complete environmental compatibility. Particular examples of cryogenic fluids include nitrogen, which has a surface tension at −193° C. of only 8.3 dynes/cm and argon. In embodiments wherein N₂ is the cryogenic fluid, the article is exposed to N₂ immersion include a temperature of −196° C. at atmospheric pressure. In this embodiment, a power intensity of approximately 50 watts/cm² of 20 KHz ultrasonic energy are used to effect cavitation in the liquid medium. As a result, removal of loosened contamination can be affected following approximately 1 minute of exposure to this process step.

In one embodiment for preparing a dense processing fluid, the at least one processing agent and/or co-solvent, may be added to the dense processing fluid, which optionally contains at least one fluorinated dense fluid, either before, during, and/or after transferring the dense fluid from the pressurization vessel to the processing chamber. Alternatively, the at least one processing agent and/or co-solvent, may be added to the subcritical fluid, which optionally contains at least one fluorinated fluid, in the pressurization vessel before, during, and/or after heating the pressurization vessel to transform the subcritical fluid to the dense fluid. The dense rinse fluid may be made in the same manner as the dense processing fluid except that the at least one processing agent is typically omitted.

In one embodiment, the dense processing fluid and the dense rinse fluid may be made using the method and/or apparatus such as that shown in FIGS. 3 and 4 of pending patent applications Ser. No.10/253,054 file 24 Sep. 2002 and Ser. No. 10/737,258 filed 16 Dec. 2003, respectively, which are both assigned to the assignee of the present invention and incorporated herein by reference in its entirety. These apparatuses illustrate an isochoric (constant volume) carbon dioxide pressurization system to generate a carbon dioxide dense fluid for an ultrasonic electronic component cleaning chamber or processing tool, and includes a carbon dioxide recovery system to recycle carbon dioxide after separation of extracted contaminants. In the referenced figures, the processing chamber is fitted with an agitation source such as ultrasonic generator which is an ultrasonic transducer array connected to high frequency power supply. The ultrasonic transducer may be any commercially available unit such as, for example, an ultrasonic horn from Morgan Electro Ceramics of Southampton, England. Ultrasonic generator typically may be operated in a frequency range of from 20 KHz to 2 MHz. As used herein, the term “ultrasonic” refers to any wave or vibration having a frequency above the human audible limit of about 20 KHz. A high frequency power supply typically provides power in an ultrasonic power density range of about 20 W/in² to about 40 W/in².

In an alternative embodiment, the dense fluid, dense processing fluid, and/or dense rinse fluid may be prepared by bringing the fluid to its supercritical state using a compressor, pump, or similar means.

The dense processing fluid, processing fluid and/or the dense rinse fluid can be contacted with the partially treated article and/or article using a dynamic method, a static method, or combinations thereof. In the dynamic method, a dense processing fluid or a dense rinse fluid is applied to the partially treated article and/or article by flowing or spraying the fluid, such as for example, by adjusting inlet flow and pressure, to maintain the necessary contact time. Alternatively, the contact steps may be conducted using a static method such as for example, immersing the article within a chamber containing the dense processing fluid or dense rinse fluid or applying the dense processing fluid or the dense rinse fluid to the article and allowing it to contact the dense processing fluid or the dense rinse fluid for a certain period of time.

In some embodiments, the dense processing fluid or processing fluid can be applied to the surface of the article after the introduction of the at least one processing agent and optional co-solvent, by first treating the article with the at least one processing agent and optional co-solvent and then placing the article in contact with the dense fluid to provide the dense processing fluid. Alternatively, the dense processing fluid and the at least one processing agent and optional co-solvent may be introduced into the vessel sequentially, such as, for example, by first introducing the dense fluid and subsequently introducing the processing agent and optional co-solvent. In this case, the dense processing fluid may be formed in multiple steps during the processing of the article. In still further embodiments of the present invention, the processing agent can be deposited upon or comprise the material of a high surface area device such as a cartridge or filter (which may or may not include other additives). A stream of dense fluid then passes through the cartridge or filter thereby forming the dense processing fluid. In still another embodiment of the present invention, the dense processing fluid is prepared during the contacting step. In this connection, at least one processing agent is introduced via a dropper or other means to the surface of the article. The dense fluid medium is then introduced to the surface of the article which mixes with the at least one processing agent on the surface of the article thereby forming the dense processing fluid. Other alternatives include immersing the article in a pressurized, enclosed chamber and then introducing the appropriate quantity of processing agent.

Typically, the treating step may be performed by placing an article having contaminants within a high-pressure chamber and heating the chamber to the desired temperature. The article may be placed vertically, at an incline, or in a horizontal plane. The dense processing fluid can be prepared prior to its contact with the article surface. For example, a certain quantity of one or more processing agents and optionally a co-solvent can be injected into a continuous stream of the dense fluid medium thereby forming the dense processing fluid. The dense processing fluid can also be introduced into the heated chamber before or after the chamber has been pressurized to the desired operating pressure. During at least a portion of the contacting step with the dense processing fluid, the partially treated article is contacted with a dense rinse fluid.

In one particular embodiment, the desired pressure can be obtained by introducing dense fluid into an enclosed chamber. In this embodiment, additional processing agents, co-solvents, chelating agents, and entrainers may be added at an appropriate time prior to and/or during the contacting step. The processing agent, or a mixture thereof, forms the dense processing fluid after the processing agent and dense fluid have been combined. The dense processing fluid then contacts the article and the contaminant associates with the processing agent and/or mixture thereof, and becomes entrained in the fluid. Depending on the conditions employed in the separation process, varying portions of the contaminant may be removed from the article, ranging from relatively small amounts to nearly all of the contaminant.

During the treating steps, the chamber temperature can range from 10 to 100° C., or from 20 to 70° C., or from 25 to 60° C. The operating pressure can range from 1000 psig to 8000 psig (69 to 552 bar), or from 2000 psig to 6000 psig (138 to 414 bar), or from 2500 to 4500 psig (172 to 310 bar). Optional agitation methods such as ultrasonic energy, mechanical agitation, fluidic jet agitation, pressure pulsing, or any other suitable mixing technique, used alone or in combination, may be used to enhance cleaning efficiency and contaminant removal. In one embodiment, the article is contacted with the dense processing fluid while applying ultrasonic energy during at least a portion of the treating step. In this embodiment, the ultrasonic energy may be applied using the method and/or apparatus disclosed, for example, in pending U.S. patent application Ser. No. 10/737,458, which was filed on 16 Dec. 2003 which are assigned to the assignee of the present invention and incorporated herein by reference in their entirety.

Any of the elements contained within the dense processing fluid or dense rinse fluid may be recycled for subsequent use in accordance with known methods. For example, in one embodiment, the temperature and pressure of the vessel may be varied to facilitate removal of residual processing agent and/or co-solvent from the article or substrate being cleaned. In an alternative embodiment, one or more components of the dense fluid such as, for example, the perfluorinated and fluorochemical dense fluid, may be separated and recovered using the methods and apparatuses disclosed in U.S. Pat. Nos. 5,730,779; 5,976,222; 6,032,484; and 6,383,257, which are assigned to the assignee of the present invention and incorporated herein by reference in their entirety.

The following Examples illustrate embodiments of the method described herein but do not limit the embodiments to any of the specific details described therein.

### EXAMPLES

The following examples were performing using a test system that included a 500 cm³ heated processing chamber for generating a dense processing fluid and/or dense rinse fluid comprising CO₂. The chamber was capable of reaching temperatures up to 100° C. and pressures up to 400 bar. The chamber could also process samples having a diameter as large as 5 cm. The test system was fully compatible with a variety of processing agents, co-solvents, chelating agents, and entrainers. Pressurization and de-pressurization steps were automatically controlled using a programmable CO₂ piston pump and a programmable pressure regulator. The processing chamber temperature were automatically controlled using externally mounted heating elements. The flow rate and pressure of processing agents, co-solvents, chelating agents, and/or entrainers were automatically controlled using a second piston pump. Unless otherwise stated, in the following examples, CO₂, processing agents, co-solvents, chelating agents, and/or entrainers were combined in a flowing stream before entering the processing chamber. The chamber's process ports are designed to provide controlled, unidirectional flow of fluids through the vessel. The dense fluid CO₂ was provided from a high purity liquid source. All system components were designed to maintain high purity and low suspended particle concentration in the CO₂ and liquid additive streams.

### Example 1

A silicon article having a dielectric thin film was covered with a photoresist and was exposed to a lithographic and an etching process to form topographical features such as trenches. After processing, the photoresist material on the article surface contained a cross-linked polymer that was still permeable to vertical penetration by one or more dense fluids. The article was similar to the article depicted in FIG. 1a, except it had topographical features.

The article was placed in the processing chamber. In a separate vessel, a mixture was prepared that contained 76 wt. % of DMSO, 6 wt. % water and 18 wt. % of a TMAH/water solution (which consisted of 25 wt. % TMAH and 75 wt. % water). The mixture was then combined with CO₂ in its dense fluid state at 30 wt. % to provide the dense processing fluid (i.e., the dense processing fluid containing 70 wt. % of the mixture and 30 wt. % of the dense fluid CO₂). The article was treated with the dense processing fluid in the processing chamber at a pressure of 4000 psig, a temperature of 60° C., and for a time of 80 minutes. During at least a portion of this treatment step, the article was also exposed to the agitation source, 20 KHz ultrasonic energy, four times during the treatment duration at a duration of 60 seconds each.

A second mixture was prepared that contained 97 wt. % of ethanol and 3 wt. % of water. To this second mixture, a certain amount of dense fluidic CO₂ was added to provide a dense rinse fluid containing 90 wt. % of CO₂ in the dense fluid state and 10 wt. % of the second mixture. The article was then contacted with a dense rinse fluid in the processing chamber to partially extract remaining liquids from the substrate using the same pressure, temperature, and time duration as the treatment step. Like the treatment step, the contacting step was also enhanced with 20 KHz ultrasonic energy using the same conditions as above.

After the liquid-based contaminants were loosened, the photoresist was still completely present on the surface of the article in a slightly wet condition. To further remove the wet, loosened contaminants, the article was then exposed to a final processing fluid containing 100% deionized water at atmospheric temperature and pressure for a period of 30 seconds. During the exposure step, the article was also exposed to 20 KHz ultrasonic energy for a duration of 30 seconds. The removed photoresist material remained in the final processing fluid.

Subsequent inspection of the surface under scanning electron microscopy revealed that more than 95% of the photoresist was removed. This removal generally occurred across the entire surface of the substrate, i.e., near etched structures and in flat areas, away from vias, trenches and the like. There was no etching damage to the dielectric substrate and there was no collapse of patterns following exposure to the water rinse.

### Example 2

An article consisting of SiO₂ and dielectric thin films deposited on a copper layer was covered with a multi-layered photoresist film. The multi-layered film consisted of acrylic polymer covering a glass layer, which covered a polymer sub-layer. This stratified photoresist was impermeable to vertical penetration by dense phase fluid mixtures. The article was exposed to lithographic and etching processes to form surface features. The resulting substrate topography contained regions of closely spaced vias separated by open regions containing no etched features. The article was similar to the article depicted in FIG. 1b.

The article was placed in the processing chamber. In a separate vessel, a mixture was prepared that contained 44.6 wt. % of DMAC, 30 wt. % ethanol and 25.4 wt. % of a TBAF/water solution (which consisted of 25 wt. % TBAF and 75 wt. % water). The mixture was then combined with 50/50 by wt. % with ethanol and the 50/50 ethanol-containing mixture was then combined with CO₂ in its dense fluid state at 2.5 wt. % to provide the dense processing fluid (i.e., the dense processing fluid containing 2.5 wt. % of the 50/50 ethanol-containing mixture and 97.5 wt. % of the dense fluid CO₂). The article was treated with the dense processing fluid in the processing chamber at a pressure of 3000 psig, a temperature of 50° C., and for a time of 30 minutes. During at least a portion of this treatment step, the article was also exposed to the agitation source, 20 KHz ultrasonic energy, four times during the treatment duration at a duration of 60 seconds each.

A second mixture was prepared that contained 97 wt. % of ethanol and 3 wt. % of water. To this second mixture, a certain amount of the dense fluid CO₂ was added to provide a dense rinse fluid containing 90 wt. % of dense fluidic CO₂ and 10 wt. % of the second mixture. The article was then contacted with a dense rinse fluid in the processing chamber to partially extract remaining liquids from the substrate using the same pressure, temperature, and time duration as the treatment step. Like the treatment step, the contacting step was also enhanced with 20 KHz ultrasonic energy using the same conditions as above. After the liquid-based contaminants were loosened, the photoresist was still completely present on the surface of the article in a slightly wet condition.

Following these steps the photoresist was still completely present on the surface in a slightly wet condition, but was substantially loosened in some areas. To further remove the wet, loosened contaminants, the article was then exposed to a final processing fluid containing 100% deionized water at atmospheric temperature and pressure for a period of 30 seconds. During the exposure step, the article was also exposed to 20 KHz ultrasonic energy for a duration of 30 seconds. The removed photoresist material remained in the final processing fluid.

Subsequent inspection of the surface under scanning electron microscopy revealed that the tri-level photoresist was fully removed from areas containing dense etched features. The reactive agents had loosened the acrylic polymer and glass through undercutting of the underlying polymer. Undercutting had proceeded in a direction parallel to the polymer-SiO₂ interface from entry points in the sidewalls of the etched features. The loosened contaminants were then removed in the subsequent exposure step. The remaining tri-level photoresist proceeded to peel off in a direction leading away from the etched feature entry points. Further removal of the remaining photoresist contaminants would require repetition of the above treatment, contacting, and exposure steps to further undercut and remove the stratified layers.

### Example 3

The article containing photoresist and post-etch residue was placed in the processing chamber. In a separate vessel, a dense processing solution was prepared that contained CO₂ as the dense fluid, DMSO and methanol as the co-solvents, and a TMAH/water solution (which consisted of 25 wt. % TMAH and 75 wt. % water) as the processing agents. The total processing agent concentration was ˜0.3 wt % in the dense CO2 fluid and the DMSO and methanol concentrations were 3.5 wt % and 0.37 wt %, respectively. The article was treated with the dense processing fluid in the processing chamber at a pressure of 3600 psig, a temperature of 50° C., and for a time of 10 minutes. During the treatment step, the article was also exposed to the agitation source, or a mechanical agitator at an agitation rate of 500 rpm.

A second mixture was prepared that contained 97 wt. % of ethanol and 3 wt. % of water. To this second mixture, a certain amount of CO₂ in the dense fluid state was added to provide a dense rinse fluid containing 90 wt. % of the dense fluid CO₂ and 10 wt. % of the second mixture. The article was then contacted with a dense rinse fluid in the processing chamber to partially extract remaining liquids from the substrate using the same pressure, temperature, time duration, and mechanical agitation as the treatment step. The resultant article contained no photoresist contaminant on the surface as determined by electron microscopy and was completely dry.

1. A method for removing contaminants from an article, the method comprising:
(a) loosening at least a portion of the contaminants by treating the article with a treatment method selected from the following to provide a partially treated article comprising loosened contaminants:
(i) treating the article with a dense processing fluid comprising a dense fluid, a co-solvent, a processing agent, a chelating agent, and optionally an entrainer to provide the partially treated article;
(ii) treating the article with a processing fluid comprising the processing agent, optionally the co-solvent, optionally the chelating agent, and optionally the entrainer to provide the partially treated article; and
(iii) treating the article with the processing fluid comprising, an processing agent, optionally the co-solvent, optionally the chelating agent, and optionally the entrainer and then treating the article with the dense processing fluid comprising the dense fluid, the co-solvent, the processing agent, the chelating agent, and optionally the entrainer to provide the partially treated article;
(b) optionally contacting the partially treated article with a dense rinse fluid comprising a dense fluid, optionally a co-solvent, and optionally an entrainer to remove liquid-based contaminants;
(c) removing at least a portion of the loosened contaminants by exposing the partially treated article with at least one exposure method selected from the following to provide a treated article:
(i) exposing the partially treated article to a final processing fluid comprising a dense fluid component and optionally a solvent wherein the dense fluid component is in a fluid state selected from a supercritical or a subcritical fluid state provided that the loosened contaminants are wet;
(ii) exposing the partially treated article to the final processing fluid and the agitation source provided that the loosened contaminents are wet;
(iii) exposing the partially treated article to the final processing fluid wherein the final processing fluid is delivered to the surface through a plurality of fluid nozzles at a temperature and pressure sufficient to remove the loosened contaminants provided that the loosened contaminants are wet;
(iv) exposing the partially treated article to an aerosol jet at a temperature and pressure sufficient to remove the loosened contaminants provided that the loosened contaminants are dry; and
(v) exposing the partially treated article to a cryogenic liquid and the agitation source provided that the loosened contaminants are dry;
(d) restoring at least a portion of the surface of the treated and/or partially treated article by contacting the article with a mixture comprising an active agent.

2. The method of claim 1 wherein the dense fluid in the dense processing fluid, and/or the dense rinse fluid comprises one or more components selected from carbon dioxide, nitrogen, methane, oxygen, ozone, argon, hydrogen, helium, ammonia, nitrous oxide, hydrogen chloride, sulfur trioxide, and water.

3. The method of claim 2 wherein the dense fluid in the dense processing fluid and/or the dense rinse fluid comprises at least one fluorinated dense fluid selected from perfluorocarbon compounds, hydrofluorocarbons, fluorinated nitrites, fluoroethers, fluoroamines, fluorinated compounds, zeotropic mixtures of refrigerants, azeotropic mixtures of refrigerants, and combinations thereof.

4. The method of claim 1 wherein the dense fluid in the dense processing fluid and/or the dense rinse fluid comprises at least one fluorinated dense fluid selected from perfluorocarbon compounds, hydrofluorocarbons, fluorinated nitrites, fluoroethers, fluoroamines, fluorinated compounds, zeotropic mixtures of refrigerants, azeotropic mixtures of refrigerants, and combinations thereof.

5. The method of claim 1 wherein the dense fluid in the dense processing fluid, and/or the dense rinse fluid comprises one or more hydrocarbons having from 2 to 6 carbon atoms.

6. The method of claim 1 wherein the dense fluid in the dense processing fluid and the dense rinse fluid are the same.

7. The method of claim 1 wherein the dense fluid in the dense processing fluid and the dense rinse fluid are different.

8. The method of claim 1 wherein the dense fluid in the dense processing fluid and the dense rinse fluid are prepared by isochoric processing.

9. The method of claim 1 wherein the dense fluid in the dense processing fluid and the dense rinse fluid are prepared by compressor.

10. The method of claim 1 wherein the at least one processing agent is selected from a dialkyl ester, an acid, an alkyl alkanolamine, a quaternary ammonium hydroxide, a quaternary ammonium fluoride salt, an amine-epoxide adduct, an amide, an organic carbonate, a carboxylic acid, an alkane diol, an alkane, a peroxide, a water, an urea, a haloalkane, a haloalkene, a beta-diketone, a carboxylic acid, an oxine, a tertiary amine, a tertiary diamine, a tertiary triamine, a nitrile, a beta-ketoimine, an ethylenediamine tetraacetic acid and derivatives thereof, a catechol, a choline-containing compound, a trifluoroacetic anhydride, an oxime, a dithiocarbamate, and combinations thereof.

11. The method of claim 1 wherein the total concentration of the at least one processing agent in the dense processing fluid ranges from about 0.01 to about 20 wt. %.

12. The method of claim 1 wherein the agitation source is selected from fluid jets, brushes, spinning, ultrasonic energy, sonic energy, linear fluid flow impingement, circular fluid flow impingement, and combinations thereof.

13. The method of claim 1 wherein the at least one co-solvent in the dense processing fluid is selected from an ester, an ether, an alcohol, a nitrile, a hydrated nitrile, a glycol, a glycol ether, a monoester glycol, a ketone, a fluorinated ketone, an amide, a carbonate, an alkane diol, and dimethyl sulfoxide.

14. The method of claim 1 wherein at least a portion of the at least one treatment method is conducted using an agitation source.

15. The method of claim 12 wherein the at least one co-solvent is selected from an ester, an ether, an alcohol, a nitrile, a hydrated nitrile, a glycol, a glycol ether, a monoester glycol, a ketone, a fluorinated ketone, an amide, a carbonate, an alkane diol, and alkyl sulfoxide.

16. A method for removing contaminants from an article, the method comprising:
(a) loosening at least a portion of the contaminants by treating the article with a treatment method selected from the following to provide a partially treated article comprising loosened contaminants:
(i) treating the article with a dense processing fluid comprising a dense fluid, a co-solvent, a processing agent, a chelating agent, and optionally an entrainer to provide the partially treated article;
(ii) treating the article with a processing fluid comprising the processing agent, optionally the co-solvent, optionally the chelating agent, and optionally the entrainer to provide the partially treated article; and
(iii) treating the article with the processing fluid comprising, an processing agent, optionally the co-solvent, optionally the chelating agent, and optionally the entrainer and then treating the article with the dense processing fluid comprising the dense fluid, the co-solvent, the processing agent, the chelating agent, and optionally the entrainer to provide the partially treated article;
(b) contacting the partially treated article with a dense rinse fluid comprising a dense fluid, optionally a co-solvent, and optionally an entrainer to remove liquid-based contaminants;
(c) removing at least a portion of the loosened contaminants by exposing the partially treated article with at least one exposure method selected from the following to provide a treated article:
(i) exposing the partially treated article to a final processing fluid comprising a dense fluid component and optionally a solvent wherein the final processing fluid is a state selected from a supercritical or a subcritical fluid state provided that the loosened contaminants are wet;
(ii) exposing the partially treated article to the final processing fluid and the agitation source provided that the loosened contaminents are wet;
(iii) exposing the partially treated article to the final processing fluid wherein the final processing fluid is delivered to the surface through a plurality of fluid nozzles at a temperature and pressure sufficient to remove the loosened contaminants provided that the loosened contaminents are wet;
(iv) exposing the partially treated article to an aerosol jet at a temperature and pressure sufficient to remove the loosened contaminants provided that the loosened contaminants are dry; and
(v) exposing the partially treated article to a cryogenic liquid and the agitation source provided that the loosened contaminants are dry.

17. A method for removing contaminants from an article, the method comprising:
(a) loosening at least a portion of the contaminants by treating the article with a dense processing fluid comprising a dense fluid, a co-solvent, a processing agent, a chelating agent, and optionally an entrainer to provide the partially treated article;
(b) contacting the partially treated article with a dense rinse fluid comprising a dense fluid, optionally a co-solvent, and optionally an entrainer to remove liquid-based contaminants;
(c) removing at least a portion of the loosened contaminants by exposing the partially treated article with at least one exposure method selected from the following to provide a treated article:
(i) exposing the partially treated article to a final processing fluid comprising a dense fluid component and optionally a solvent wherein the final processing fluid is a state selected from a supercritical or a subcritical fluid state provided that the loosened contaminants are wet;
(ii) exposing the partially treated article to the final processing fluid and the agitation source provided that the loosened contaminents are wet;
(iii) exposing the partially treated article to the final processing fluid wherein the final processing fluid is delivered to the surface through a plurality of fluid nozzles at a temperature and pressure sufficient to remove the loosened contaminants provided that the loosened contaminents are wet;
(iv) exposing the partially treated article to an aerosol jet at a temperature and pressure sufficient to remove the loosened contaminants provided that the loosened contaminants are dry; and
(v) exposing the partially treated article to a cryogenic liquid and the agitation source provided that the loosened contaminants are dry.

18. A method for removing contaminants from an article, the method comprising:
(a) loosening at least a portion of the contaminants by treating the article with a processing fluid comprising the processing agent, optionally the co-solvent, optionally the chelating agent, and optionally the entrainer to provide the partially treated article;
(b) contacting the partially treated article with a dense rinse fluid comprising a dense fluid, optionally a co-solvent, and optionally an entrainer to remove liquid-based contaminants;
(c) removing at least a portion of the loosened contaminants by exposing the partially treated article with at least one exposure method selected from the following to provide a treated article:
(i) exposing the partially treated article to a final processing fluid comprising a dense fluid component and optionally a solvent wherein the final processing fluid is a state selected from a supercritical or a subcritical fluid state provided that the loosened contaminants are wet;
(ii) exposing the partially treated article to the final processing fluid and the agitation source provided that the loosened contaminents are wet;
(iii) exposing the partially treated article to the final processing fluid wherein the final processing fluid is delivered to the surface through a plurality of fluid nozzles at a temperature and pressure sufficient to remove the loosened contaminants provided that the loosened contaminents are wet;
(iv) exposing the partially treated article to an aerosol jet at a temperature and pressure sufficient to remove the loosened contaminants provided that the loosened contaminants are dry; and
(v) exposing the partially treated article to a cryogenic liquid and the agitation source provided that the loosened contaminants are dry.

19. A method for removing contaminants from an article, the method comprising:
(a) loosening at least a portion of the contaminants by treating the article with the processing fluid comprising, an processing agent, optionally the co-solvent, optionally the chelating agent, and optionally the entrainer and then treating the article with the dense processing fluid comprising the dense fluid, the co-solvent, the processing agent, the chelating agent, and optionally the entrainer to provide the partially treated article;
(b) contacting the partially treated article with a dense rinse fluid comprising a dense fluid, optionally a co-solvent, and optionally an entrainer to remove liquid-based contaminants;
(c) removing at least a portion of the loosened contaminants by exposing the partially treated article with at least one exposure method selected from the following to provide a treated article:
(i) exposing the partially treated article to a final processing fluid comprising a dense fluid component and optionally a solvent wherein the final processing fluid is a state selected from a supercritical or a subcritical fluid state provided that the loosened contaminants are wet;
(ii) exposing the partially treated article to the final processing fluid and the agitation source provided that the loosened contaminents are wet;
(iii) exposing the partially treated article to the final processing fluid wherein the final processing fluid is delivered to the surface through a plurality of fluid nozzles at a temperature and pressure sufficient to remove the loosened contaminants provided that the loosened contaminents are wet;
(iv) exposing the partially treated article to an aerosol at a temperature and pressure sufficient to remove the loosened contaminants provided that the loosened contaminants are dry; and
(v) exposing the partially treated article to a cryogenic liquid and the agitation source provided that the loosened contaminants are dry.
